(19) United States
(12) Patent Application Publication
(10) Pub. No.: US 2008/0297412 A1
(43) Pub. Date: Dec. 4, 2008

(54) GPS RECEPTION DEVICE

(75) Inventor: Hiroshi HAMADA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/130,964

(22) Filed: May 30, 2008

(30) Foreign Application Priority Data
May 31, 2007 (JP) 2007-145455

(51) Int. Cl. G01S 1/00

(52) U.S. Cl. 342/357.13; 342/357.15

(57) ABSTRACT

According to one embodiment, a GPS reception device includes a section which acquires information in radio signals from satellites, a storage section which stores parameters to select part of the satellites, a section which calculates pseudo-distances from the satellites to a reception point based on the acquired information and measures the position of the reception point based on calculation results obtained for the selected part, and a touch panel display which inputs the position of a known reception point. The device includes a section which calculates real distances from the satellites to the known reception point when the position is input, determines ranges of elevation and azimuth angles suitable for the measurement based on the elevation and azimuth angle values of the satellites preferentially set in an order in which differences between the real distances and the pseudo-distances become smaller and sets the ranges as parameters into the storage section.

### CROSS-REFERENCE TO RELATED APPLICATIONS

This application is based upon and claims the benefit of priority from Japanese Patent Application No. 2007-145455, filed May 31, 2007, the entire contents of which are incorporated herein by reference.

### BACKGROUND

1. Field

One embodiment of the present invention relates to a GPS reception device which measures the position of a reception point by using GPS satellites and more particularly to a GPS reception device incorporated into a mobile instrument used in an urban area.

2. Description of the Related Art

Recently, portable devices such as mobile phones and personal digital assistants (PDAs) are actively and popularly used. Most of the portable devices contain GPS receivers to determine the present position of the user. “GPS” is an abbreviation for “Global Positioning System” and is a satellite navigation system made open to the public by the Pentagon. In the system, four of 24 GPS satellites in total are arranged on each of six orbital planes which make an orbital inclination angle of 55°. Each GPS satellite transmits a radio signal from the known position in the orbital plane. The radio signals contain measurement information in GPS signal format. The measurement information contains almanac data including orbital information items of all of the other satellites and ephemeris data including precise position information of itself and transmission time information. The almanac data is mainly used to determine the GPS satellites which are available immediately after the power switch of the GPS reception device is turned on and the ephemeris data is used to actually measure the position of a reception point. The GPS reception device is required to use at least four satellites for measurement in accordance with unknown quantities of the latitude, longitude, altitude and reception time of the reception point and measures the position of the reception point based on measurement information acquired by receiving the radio signals from the four satellites.

In the mobile instrument, the measured position of the reception point is indicated by a specified mark displayed on the display together with a map. The user of the mobile instrument refers to the mark and confirms the present position of the user while he is moving. For example, when he moves on foot, it is necessary for the GPS reception device to perform the measurement operation with high precision in order to reflect a slight variation in the position of the reception point upon the mark on the map. However, large buildings such as high-rise buildings are built in the neighboring area in the urban area in many cases and the radio signals from the GPS satellites are reflected from the buildings and reach the GPS reception device through a path longer than the actual case. In this state, a measurement error will be increased.

The GPS reception device captures at least four satellites by use of set parameters such as ranges of elevation angles and azimuth angles. Conventionally, as a measure for reducing the measurement error, a method for providing urban set parameters and suburb set parameters in addition to standard set parameters and separately and adequately using the above parameters according to the situation is proposed (for example, refer to Jpn. Pat. Appln. KOKAI Publication No. 2004-12426).

In the case of the urban set parameters disclosed in Jpn. Pat. Appln. KOKAI Publication No. 2004-12426, larger elevation angles are set for higher satellites to be captured in comparison with the case of the suburb set parameters in order to suppress an influence by attenuation and reflection of radio signals by and on the buildings. However, setting of such elevation angles may make it difficult to capture available GPS satellites and the measurement error cannot be reduced as expected in the urban area in some cases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram schematically showing the circuit configuration of a GPS reception device according to one embodiment of this invention.

FIG. 2 is an exemplary diagram showing the flow of a position correction process performed by a control section shown in FIG. 1.

FIG. 3 is an exemplary view showing a neighboring area map displayed on a touch panel display shown in FIG. 1.

FIG. 4 is an exemplary diagram showing the positional relation between the GPS reception device shown in FIG. 1 and satellites used for measurement.

FIG. 5 is an exemplary diagram showing simultaneous equations to derive the position of a reception point in the positional relation shown in FIG. 4.

### DETAILED DESCRIPTION

Various embodiments according to the invention will be described hereinafter with reference to the accompanying drawings. In general, according to one embodiment of the invention, there is provided a GPS reception device which includes a reception processing circuit which receives radio signals from a plurality of satellites and acquires measurement information contained in the radio signals, a parameter storage section which stores parameters used to select part of the satellites, a measurement processing section which calculates pseudo-distances from the satellites to a reception point based on the measurement information acquired by the reception processing circuit and measures the position of the reception point based on the calculation results respectively obtained for the part of the satellites selected according to the parameters, an input section which inputs a position of a known reception point, and a control circuit which calculates real distances from the satellites to the known reception point when the position of the known reception point is input by the input section, determines ranges of elevation angles and azimuth angles suitable for the measurement based on the elevation angle values and azimuth angle values of the satellites preferentially set in an order in which differences between the real distances and the pseudo-distances become smaller and sets the ranges of elevation angles and azimuth angles as the parameters into the parameter storage section.

In the GPS reception device, when the position of the known reception point is input by the input section, the control circuit calculates real distances from a plurality of satellites to a known reception point, determines ranges of elevation angles and azimuth angles suitable for measurement based on the elevation angle values and azimuth angle values of the satellites preferentially set in an order in which differences between the real distances and the pseudo-distances become smaller and sets the ranges of elevation angles and azimuth angles as parameters into the parameter storage section. In the urban area, spaces open to areas in which no obstacles are present are continuously provided along streets between buildings in many cases and the users generally move along the streets. That is, when the user inputs the position of a known reception point, the ranges of the elevation angle and azimuth angle which permit the radio signals from the satellites to be directly received without being substantially influenced by the surrounding buildings are determined and set in the parameter storage section. Therefore, the measurement precision in the urban area can be easily improved.

Next, the GPS reception device according to one embodiment of this invention is explained. The GPS reception device is incorporated into a mobile instrument such as a PDA and portable telephone used while the user is moving on foot and utilizes 24 GPS satellites in total to measure the position of a reception point. Each GPS satellite transmits a radio signal from the known position in the orbital plane. The radio signals contain measurement information in GPS signal format. The measurement information contains almanac data including orbital information items of all of the other satellites and ephemeris data including precise position information of itself and transmission time information. The almanac data is mainly used to determine GPS satellites which are made available immediately after the power switch of the GPS reception device is turned on and the ephemeris data is used to actually measure the position of the reception point. The GPS reception device is required to use at least four satellites for measurement in accordance with the latitude, longitude, altitude and reception time which are unknown and measures the position of the reception point based on measurement information acquired by receiving the radio signals from the four satellites.

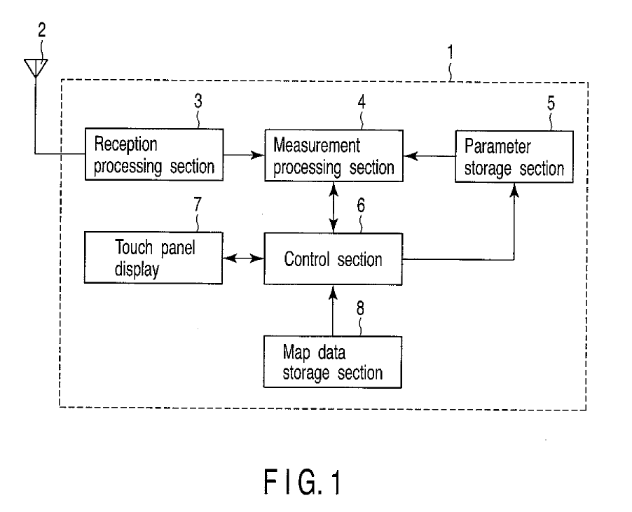

FIG. 1 schematically shows the circuit configuration of a GPS reception device 1. The GPS reception device 1 includes an antenna 2, reception processing section 3, measurement processing section 4, parameter storage section 5, control section 6, touch panel display 7 and map data storage section 8. The reception processing section 3 cooperates with the antenna 2 to configure a reception processing circuit which receives radio signals from a plurality of GPS satellites and acquires measurement information items contained in the radio signals. The parameter storage section 5 stores parameters used to select at least four satellites as part of the satellites. The measurement processing section 4 configures a measurement processing circuit which calculates pseudo-distances from the satellites to the reception point based on the measurement information acquired by the reception processing section 3 and measures the position of the reception point based on the calculation results obtained for the respective satellites selected according to the parameters stored in the parameter storage section 5.

The control section 6, touch panel display 7 and map data storage section 8 configure a control circuit which calculates real distances from the satellites to a known reception point when the position of a known reception point is input and sets ranges of elevation angles and azimuth angles suitable for measurement as parameters into the parameter storage section 5 based on the elevation angle values and azimuth angle values of the satellites preferentially set in an order in which differences between the real distances and the pseudo-distances become smaller. The map data storage section 8 is provided to store map data and the touch panel display 7 is provided to display the map. Further, the touch panel display 7 can input the position of a known reception point and the control section 6 performs the control operation for the operation of the control circuit described above when the position of the known reception point is input by use of the touch panel display 7. Further, the control circuit 6 is configured to display a map of a neighboring area of the reception point obtained from the map data and a mark of the reception point arranged in the neighboring area map on the touch panel display 7 based on the measurement results of the measurement processing section 4. For example, the touch panel display 7 may be configured by superimposing a transparent touch panel on a liquid crystal display panel and integrating the panels into one unit. In this example, the touch panel is also used as an input section which inputs the position of the known reception point by operating a pointer such as a touch pen with respect to the neighboring area map. In addition, the control section 6 is configured to enlarge the neighboring area map in order to input the position of the known reception point.

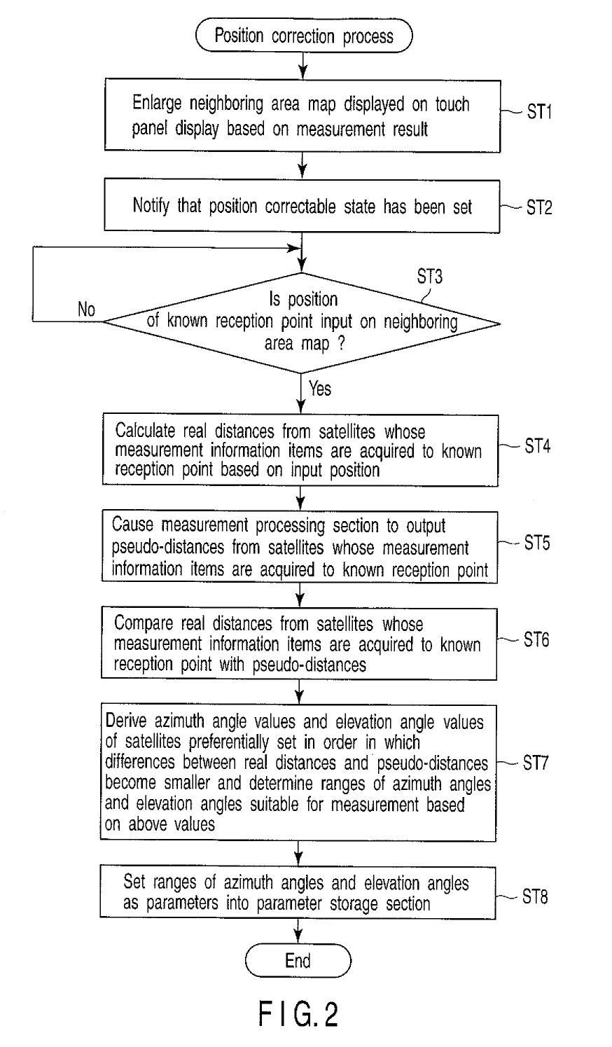

Next, the position correction process performed by the control section 6 when the position of a reception point obtained as the measurement result is wrong is explained. FIG. 2 shows the flow of the position correction process. The position correction process is started according to a position correction request input from the touch panel by operating the touch pen, for example. When the position correction process is actually started, the control section 6 enlarges the neighboring area map displayed on the touch panel display 7 based on the measurement result in step ST1 and causes the touch panel display 7 to display a message indicating that the position correctable state has been set in step ST2. The control section 6 checks whether or not a known reception point is input on the neighboring area map in step ST3. The known reception point is the real present position confirmed by the user who looks around the surroundings. The control section 6 calculates the real distances from a plurality of satellites from which the measurement information items are acquired to the known reception point based on the input position in step ST4. Then, the control section 6 causes the measurement processing section 4 to output pseudo-distances from the satellites from which the measurement information items are acquired to the known reception point in step ST5. In step ST6, the control section 6 compares the real distances from the satellites to the known reception point acquired in step ST4 with the pseudo-distances from the satellites to the known reception point acquired in step ST5. In step ST7, the control section 6 derives elevation angle values and azimuth angle values of the satellites preferentially set in an order in which differences between the real distances and the pseudo-distances become smaller and determines the ranges of elevation angles and azimuth angles suitable for measurement based on the above values. In step ST8, the control section 6 sets the ranges of elevation angles and azimuth angles as parameters into the parameter storage section 5. As a result, the differences in the pseudo-distances of at least four satellites selected as part of the satellites become small and the mark of the reception point is moved to the known reception point.

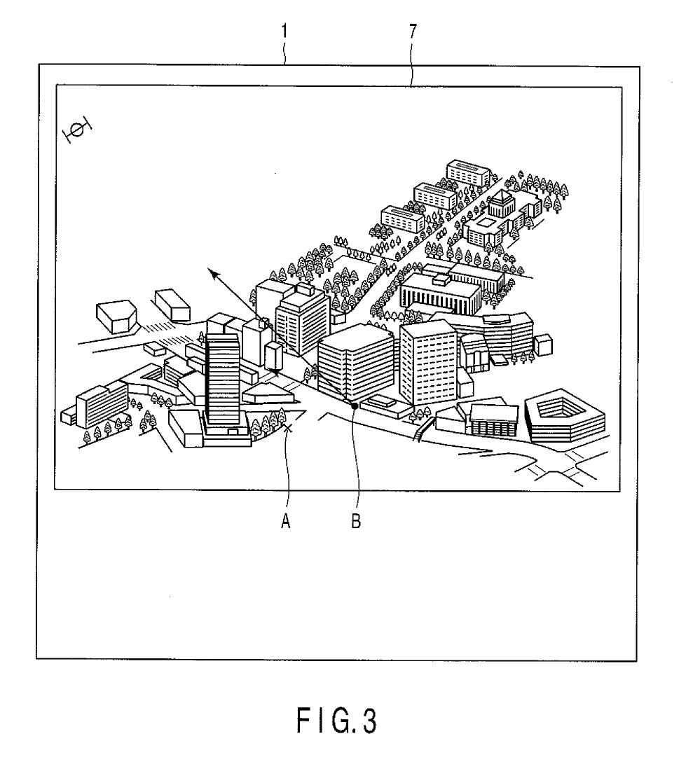

FIG. 3 shows a map of a neighboring area displayed on the touch panel display 7 shown in FIG. 1. In this example, the neighboring area map is enlarged as a relief map but it can be enlarged as a two-dimensional map. The present position of the user is a position B in some cases when the mark of the reception point is displayed in a position A on the neighboring area map as the measurement result. In this case, if the user specifies the position B as the known reception point by issuing a position correction request and touching the position by use of the touch pen, the ranges of optimum elevation angles and azimuth angles in the position B are set as parameters used to select part of the satellites. More specifically, the azimuth angle is determined along the main street and the elevation angle is set at a relatively small value.

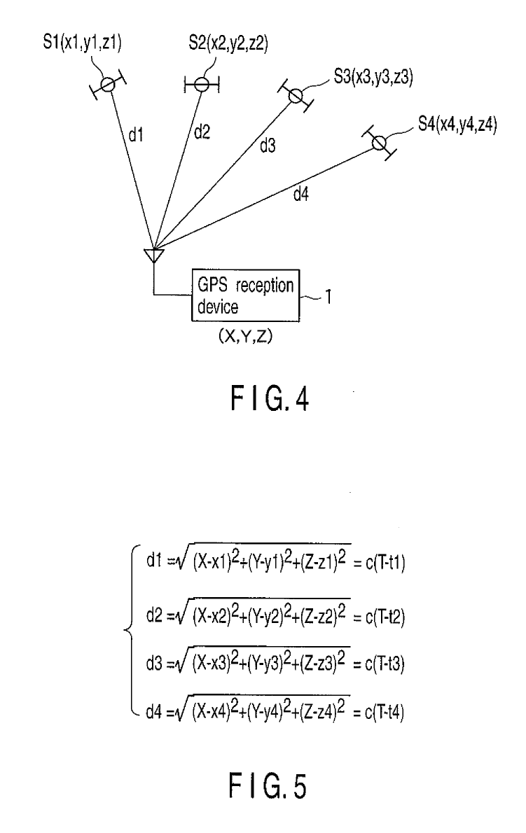

FIG. 4 shows the positional relation between the GPS reception device and satellites used for measurement. Three unknown quantities of the location of the GPS reception device, that is, the position (latitude X, longitude Y, altitude Z) of the reception point can be attained by solving simultaneous equations prepared for the three satellites. However, since the built-in clock of the GPS reception device does not have the high precision unlike an atomic clock provided in the GPS satellite, use of the built-in clock increases the error. Therefore, it is necessary to calculate the present time T as an unknown quantity and solve simultaneous equations prepared for four satellites S1, S2, S3, S4. It is assumed that the ephemeris data items of the four satellites are respectively set to (x1, y1, z1, t1), (x2, y2, z2, t2), (x3, y3, z3, t3), (x4, y4, z4, t4), the distances from the satellites S1, S2, S3, S4 to the position (X, Y, Z) of the reception point are respectively set to d1, d2, d3, d4 and the speed of light is c. Then, four simultaneous equations shown in FIG. 5 are established and the position of the reception point can be derived by solving the four simultaneous equations. In this example, the position of the reception point is expressed by the latitude X, longitude Y and altitude Z, but the measurement can be made by use of three satellites when the position of the reception point is expressed only by the latitude X and longitude Y.

In the present embodiment, when the position of a known reception point is input, the control section 6 calculates real distances from the satellites to the known reception point, determines ranges of elevation angles and azimuth angles suitable for measurement based on the elevation angle values and azimuth angle values of satellites preferentially set in an order in which differences between the real distances and pseudo-distances become smaller and sets the ranges of elevation angles and azimuth angles as the parameters into the parameter storage section 5. In the urban area, spaces open to areas in which no obstacles are present are continuously provided along streets between buildings in many cases and the users generally move along the streets. That is, when the user inputs the position of a known reception point, the ranges of the elevation angle and azimuth angle which permit the radio signals from the satellites to be directly received without being substantially influenced by the surrounding buildings can be determined and set in the parameter storage section 5. Therefore, the measurement precision in the urban area can be easily improved.

The above embodiment can be variously modified without departing from the technical scope thereof.

For example, the touch panel display 7 can be commonly used as the operation panel and display of the mobile instrument.

Further, the above embodiment is applicable to a differential GPS system used to enhance the measurement precision by correcting the GPS measurement result by use of an FM broadcast radio signal transmitted from a base station whose position is known in order to cope with a temporary lowering in the precision in time information from a satellite.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A GPS reception device comprising:
a reception processing circuit configured to receive radio signals from a plurality of satellites and to acquire measurement information contained in the radio signals,
a parameter storage section configured to store parameters used to select at least two of the satellites,
a measurement processing section configured to calculate pseudo-distances from the satellites to a reception point based on the measurement information acquired by the reception processing circuit and to measure the position of the reception point based on calculation results respectively obtained for the selected satellites,
an input section configured to input a position of a known reception point, and
a control circuit configured to calculate real distances from the satellites to the known reception point when the position of the known reception point is input by use of the input section, to determine ranges of elevation angles and azimuthal angles suitable for the measurement based on the elevation angle values and azimuthal angle values of the satellites preferentially set in an order so that differences between the real distances and the pseudo-distances become smaller and sets the ranges of elevation angles and azimuthal angles as the parameters into the parameter storage section.

2. The GPS reception device of claim 1, wherein the control circuit comprises a map data storage section configured to store map data, a display section configured to display a map and a display control section configured to display a neighboring area map of the reception point obtained from the map data and a mark of the reception point arranged in the neighboring area map based on a measurement result of the measurement processing circuit.

3. The GPS reception device of claim 2, wherein the display section is a touch panel display which can be also used as the input section, configured to allow a user to input the position of the known reception point by operating a pointer with respect to the neighboring area map.

4. The GPS reception device of claim 3, wherein the display control section is configured to enlarge the neighboring area map for aiding the user input the position of the known reception point.

5. The GPS reception device of claim 1, wherein the GPS reception device is incorporated in a mobile instrument used while a user is walking.
